(19) United States
(12) Patent Application Publication
(10) Pub. No.: US 2013/0188180 A1
(43) Pub. Date: Jul. 25, 2013

(54) SIGHTING DEVICE

(71) Applicant: Daniel Jakob, Schoenbuehl (CH)

(72) Inventor: Daniel Jakob, Schoenbuehl (CH)

(73) Assignee: MB-MICROTEC AG, Niederwangen bei Bern (CH)

(21) Appl. No.: 13/824,490

(22) PCT Filed: Sep. 20, 2011
(86) PCT No.: PCT/EP2011/066275

§ 371 Date: Mar. 18, 2013

(30) Foreign Application Priority Data
Sep. 21, 2010 (AT) A 1568/2010

(51) Int. Cl. G01C 15/00

(52) U.S. Cl. CPC G01C 15/00
USPC 356/248

(57) ABSTRACT

A sighting device (1), which is provided for aligning an apparatus connected to the sighting device (1) by aligning an axis of the sighting device (1) with a sight axis, having a self-luminous light source (2), an optical waveguide element (3) for collecting ambient light and a reticle (4) illuminated by the collected ambient light and/or the self-luminous light source (2), characterized in that provision is made for at least one optical beam deflection means (5) which is superposed on and/or coupled to the optical waveguide element (3) and the artificial light source (2), wherein the at least one beam deflection means (5) is designed to deflect the light from the artificial light source (2) and the collected ambient light and decouple it in a common emergence direction and/or to project it in the direction of the reticle (4), wherein the reticle is illuminated or formed by the decoupled light.

The invention relates to a sighting device provided for aligning an apparatus connected to the sighting device, in that an axis of the sighting device is aligned with a sight axis, comprising a self-luminous light source, an optical waveguide element for collecting ambient light and a reticle illuminated by the collected ambient light and/or the self-luminous light source.

From EP 0918243A2/A3 an optical telescope sighting system is known comprising a sighting rod with an illuminated sight mark or with an illuminated sight point as well as a construction for the specific adjustment of the illuminating intensity of the sight mark or the sight point. This known telescope sighting system is provided for use during the day and night for viewing a scene or object, for example for use with a firearm. The known system comprises an optical waveguide element for illuminating a reticle, which is provided with a closing means, by means of which the optical waveguide element can be shielded to a greater or lesser extent specifically from the ambient light in order to adjust the brightness of the reticle. Furthermore, a sight rod made of glass fiber material is provided, into which the ambient light collected by an optical waveguide and the light from an artificial light source (tritium tube) are coupled. At the tip of the sight rod the light is decoupled. The illuminated tip of the sight rod forms the reticle in this case.

A disadvantage of the known device is that it is very complex and expensive to produce. Furthermore, it is difficult for the user to manipulate said sighting device quickly when necessary. Further disadvantages of this sighting device are that the coupling of the light produced by the artificial light source into the optical waveguide element-collector is less efficient, as there is no superimposing of the light dots of the artificial light source and the ambient light. Likewise there is a significant limitation with regard to the representation of the reticle image. Furthermore, a reticle marking cannot be changed, as it is defined by the form of the tip of the sighting rod.

Therefore, it is an objective of the present invention to produce a sighting device with greater efficiency when coupling the artificial light into the reticle, which is characterized by having a simple structure and provides many different options for representing the reticle image.

The above objective is achieved by a sighting device of the aforementioned kind, in that at least one optical beam deflection means is provided which is coupled to the optical wave-guide element and the artificial light source, wherein the at least one beam deflecting means is set up to deflect the light of the artificial light source and the collected ambient light and/or decouple it in a common output direction and project it in the direction of the reticle, wherein the reticle is illuminated or formed by the decoupled light.

The solution according to the invention enables the superimposing of light dots of ambient light and light from the artificial light source. In this way a simple adjustment of the reticle to ambient light ratios is achieved, as the reticle is always illuminated to an optimum degree. The transition from day to night light conditions takes place quickly and automatically. No manual adjustment for light conditions is necessary. Furthermore, the form of the reticle can also be changed in a simple manner, for example by means of screens or masks or beam splitters. A further advantage of the invention is that for the reticle 4 superimposed day and night no additional power supply is necessary, e.g. such as a battery.

According to a preferred variant of the invention the at least one optical beam deflection means is a prism and/or a mirror and/or a beam splitter.

According to the preferred variant the total light, ambient light and artificially produced light can be enclosed in the sighting device and cannot escape to the outside. This means that there is no loss of light as such. Similarly, the sighting device, as no light escapes externally, cannot be identified e.g. by TR or residual light intensifiers.

In order to achieve greater variability of the alignment and positioning of the reticle, the at least one optical beam deflection means can be adjustable. In this connection it has proved to be particularly advantageous if the at least one optical beam deflection means is arranged to be rotatable and/displaceable and/or pivotable along an axis.

According to the preferred variant of the invention the self-luminous light source is a tritium gas light source.

In an advantageous development of the invention a screen and/or mask is provided for generating a reticle marking at least on the coupling-in side facing the artificial light source of the at least one beam deflection means and/or on the light decoupling side of the at least one beam deflection means.

It is particularly advantageous if on at least one light coupling-in side of the beam deflection means and/or on the light decoupling side of the at least one beam deflection means at least one screen and/or at least one mask is attached, whereby in an illuminated state of the screen and/or mask a pattern produced by the at least one screen and/or by the at least one mask is projected from a light decoupling side of the beam deflection element into a plane of the reticle. In the illuminated state of the beam deflection a reticle marking is projected out by the attachment of masks and/or screens on the light coupling-in side as a pattern, e.g. a cross, from the light decoupling side of the beam deflections. By simply changing the masks and screens with different patterns all possible reticle forms can be produced, e.g. dots, squares, circles and dashes.

According to one variant of the invention it is possible that for producing the artificial light, e.g. a thread with a trigalight can be fitted easily onto the sighting device. In this way threads in different trigalight colors (from the visible and non-visible range of light and the UV and IR range) can be changed easily on site and colors of trigalight can be used rapidly which are necessary for the respective light conditions and produce the best possible display of the reticle.

It is particularly advantageous if the mask is an electronic paper (e-paper). This embodiment of the invention is particularly suitable for producing any desired reticle markings or inserting any other desired information for the user.

The sighting device according to the invention is particularly suitable for use in firearms, optical measuring devices, cameras, compasses, topographical surveying devices, endoscopes and periscopes.

The invention and further advantages are explained in more detail in the following by way of a several non-restrictive exemplary embodiments, which are represented in the drawings.

The latter show in a much simplified representation:

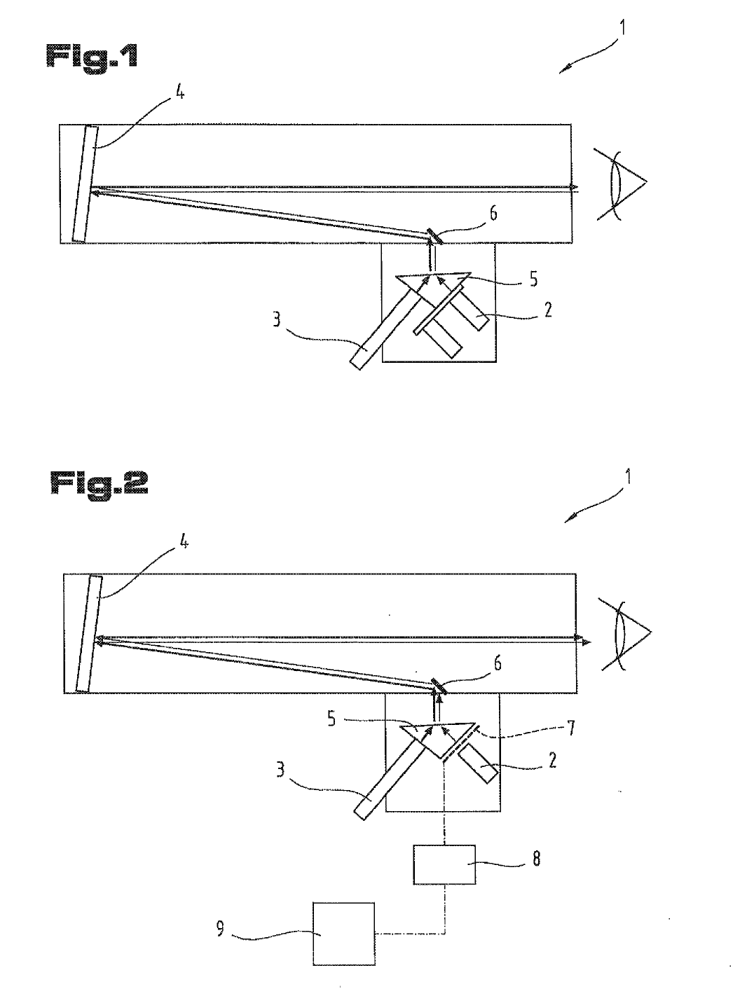

FIG. 1 a first variant of a sighting device according to the invention in the form of a reflex sight and

FIG. 2 a second variant of a sighting device according to the invention in the form of a reflex sight.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position. Furthermore, also individual features or combinations of features from the various exemplary embodiments shown and described can represent in themselves independent or inventive solutions.

According to FIG. 1 a sighting device 1 according to the invention, which can in particular be in the form of a reflex sight, comprises a self-luminous light source 2, an optical waveguide element 3 for collecting ambient light and a reticle 4 illuminated by the collected ambient light and/or the self-luminous light source 2. The optical waveguide element 3 thus represents a light collecting element and can be formed in this case by a thread. In addition, the sighting device 1 according to the invention comprises an optical beam deflection means 5, for example in the form of a prism or a mirror or also a beam splitter. If the beam deflection means 5 is in the form of a mirror, it is particularly advantageous if the latter is a semi-permeable mirror. The beam deflection means 5 is coupled with the optical waveguide element 3 and the artificial light source 2 and is thus powered by at least two separate light sources. In addition, the beam deflection means 5 is set up to deflect the light of the artificial light source 2 and the collected ambient light and decouple it in a common output direction and project it in the direction of the reticle 4. In this way the ambient light collected by the optical waveguide element 3 and the light generated by the self-luminous light source 2 are coupled together and superimposed by the beam deflection means 5. The light propagation directions of collected ambient light and light collected by the artificial light source 2 can run essentially parallel to one another after decoupling from the beam deflecting means 5. The two beam paths are superimposed and the exiting light beam is thus intensified. The reticle 4 is illuminated or formed by the light decoupled from the beam deflection means 5. Thus the reticle can be formed by a light dot which is formed according to the light conditions by ambient light and the light of the self-luminous light source 2 or in complete darkness is formed only by the artificial light source 2. If necessary the optical waveguide element 3 and the light source 2 can emit light of different colors. Also the cross sections of the preferably cylindrical light source 2 and the optical wave-guide element 3 can be of different diameters, so that by superimposing the ambient light and the light of the light source 2 in a plane of the reticle 4, which is formed here by the surface of a transparent body, for example a glass body, two different colored concentric circles can be formed.

The sighting device according to the invention is designed to align an apparatus connected to the sighting device 1, in that an axis of the sighting device 1 is aligned with a sight axis of the user. The sighting device 1 is particularly suitable for use with a firearm, optical measuring devices, for example distance measuring devices, long-range optical devices, such as telescopes or also a camera.

In order to achieve greater flexibility when positioning the reticle 4, the at least one optical beam deflection means 5 can be arranged to be adjustable. In this way the optical beam deflection means 5 can be arranged to be rotatable and/or displaceable and/or pivotable along an axis.

In addition, further optical beam deflection means can be provided, such as for example a mirror 6 connected downstream of the beam deflection means 5. The downstream beam deflection means can be pivoted about an axis and/or can be displaced in the direction of the reticle 4. In this way the position of the reticle 4 can be adjusted easily to prespecified requirements.

Furthermore, the artificial light source 2, preferably a tritium gas light source e.g. a trigalight, can comprise different colors. The colors can be changed, adapted to the ambient light, and can considerably improve the formation and/or illumination of the reticle. The color trigalight tubes can be changed very simply by means of a rotary mechanism attached to the sighting device, whereby the artificial light sources 2 can be stored in a rotatable magazine. Depending on the position of the magazine an optical contact can be formed between an artificial light source 2 and the optical beam deflection means 5.

According to FIG. 2 on the light coupling-in side of the beam deflection means 5 facing the artificial light source 2 and/or the optical waveguide element 3 a screen 7 and/or mask can be attached for producing the reticle marking. Of course, the screen 7 or mask can also be arranged on the light decoupling side of the beam deflection means 5. By simply changing the masks and screens having different patterns all possible forms of the reticle can be produced, e.g. dots, squares, circles and dashes, and are projected from the light decoupling side of the beam deflection.

The mask on the coupling-in side of the artificial light source can also be a liquid display (e.g. LCD) or an active matrix display (e.g. AMLCD) or a display with thin-film transistors. In this way also any information can be inserted into the beam path and made visible to the user. In this way the user could select one of several different representations of the reticle stored in a memory device 8, different types of cross hairs, circles etc. The memory device 8 can be connected for this purpose with a control 9 for controlling the screen 7 formed for example by an LCD screen. Additional information can also be inserted such as the humidity, air pressure, geographical height etc.

The exemplary embodiments show possible embodiment variants, whereby it should be noted at this point that the invention is not restricted to the embodiment variants shown in particular, but rather various different combinations of the individual embodiment variants are also possible and this variability, due to the teaching on technical procedure, lies within the ability of a person skilled in the art in this technical field. Thus all conceivable embodiment variants, which are made possible by combining individual details of the embodiment variants shown and described, are also covered by the scope of protection.

### LIST OF REFERENCE NUMERALS

1 sighting device

2 light source

3 optical waveguide element

4 reticle

5 optical beam deflection means

6 mirror

7 screen

8 memory

9 control

1-9. (canceled)

10: A sighting device for aligning an apparatus connected to the sighting device by aligning an axis of the sighting device with a sight axis, comprising:
a self-luminous light source;
an optical waveguide element for collecting ambient light;
a reticle illuminated by the collected ambient light and/or the self-luminous light source;
at least one optical beam deflection means coupled with the optical waveguide element and the self-luminous light source,
wherein the at least one optical beam deflection means is set up to deflect light of the self-luminous light source and the collected ambient light and decouple the light in a common output direction and/or project the light in a direction of the reticle, the reticle being illuminated or formed by the decoupled light,
wherein the self-luminous light source comprises tritium gas light sources of different colors, which are stored in a rotatable magazine, and
wherein according to a position of the magazine, an optical contact is produced between a tritium gas light source and the beam deflection means.

11: The sighting device as claimed in claim 10, wherein the at least one optical beam deflection means is a prism, a mirror or a beam splitter.

12: The sighting device as claimed in claim 10, wherein the at least one optical beam deflection means is adjustable.

13: The sighting device as claimed in claim 10, wherein the at least one optical beam deflection means is rotatable, displaceable or pivotable along an axis.

14: The sighting device as claimed in claim 10, wherein a screen or mask is attached for producing a reticle marking at least on a coupling-in side facing the self-luminous light source of the at least one beam deflection means, or on a light decoupling side of the at least one beam deflection means.

15: The sighting device as claimed in claim 10, wherein on at least one light coupling-in side of the beam deflection means or on a light decoupling side of the at least one beam deflection means, at least one screen or at least one mask is attached, wherein in an illuminated state of the screen or mask a pattern generated by the at least one screen or mask is projected from a light decoupling side of the beam deflecting element into a plane of the reticle.

16: The sighting device as claimed in claim 13, wherein the mask is an electronic paper.

17: A use of the sighting device as claimed in claim 10 for firearms, optical measuring devices, cameras, compasses, topographical surveying devices, endoscopes and periscopes.
